(19) United States
(12) Patent Application Publication
(10) Pub. No.: US 2024/0042526 A1
(43) Pub. Date: Feb. 8, 2024

(54) Rapid Process for Forming Small Area Fill Features

(71) Applicant: LAYERWISE NV, Leuven (BE)

(72) Inventors: Sam Coeck, Boutersem (BE); Gokula Krishna Muralidharan, Leuven (BE)

(21) Appl. No.: 18/363,839

(22) Filed: Aug. 2, 2023

Related U.S. Application Data
(60) Provisional application No. 63/395,157, filed on Aug. 4, 2022.

(51) Int. Cl. B22F 10/366; B22F 10/85; B22F 12/30; B22F 12/47

(52) U.S. Cl. CPC B22F 10/366; B22F 10/85; B22F 12/30; B22F 12/47; B33Y 10/00

(57) ABSTRACT

A method for manufacturing includes operating a beam system selectively to fuse and melt a powder layer to form each layer of a 3D article. Each layer includes at least one fused solid area that defines a dimensional parameter such as a width. When the dimensional parameter is above a threshold, the beam system is operated with a first operating mode that includes separately fused contour and hatch areas. When the dimensional parameter is below the threshold, the beam system is operated with a second operating mode that includes a zig-zag pattern with no contour. This method of operation can greatly reduce a time required to fuse complex layers having many very small features.

### CROSS REFERENCE TO RELATED APPLICATIONS

This non-provisional patent application claims priority to U.S. Provisional Application Ser. No. 63/395,157, Entitled “Rapid Process for Forming Small Area Fill Features” by Sam Coeck et al., filed on Aug. 4, 2022, incorporated herein by reference under the benefit of U.S.C. 119(e).

### FIELD OF THE INVENTION

The present disclosure concerns an apparatus and method for the fabrication of three dimensional (3D) articles through a layer-by-layer melting and fusion of powder materials. More particularly, the present disclosure concerns a manufacturing method for increasing system speed and efficiency for manufacturing articles having many small features such as lattice structures.

### BACKGROUND

Three dimensional (3D) printing systems are in rapidly increasing use for purposes such as prototyping and manufacturing. One type of three dimensional printer utilizes a layer-by-layer process to form a three dimensional (3D) article of manufacture from powdered materials. Each layer of powdered material is selectively melted and fused using an energy beam such as a laser, electron, or particle beam. The selective fusion of a layer is applied to one or more “solid areas” which are areas within a particular layer to be fused. A solid area is bounded by a boundary which can include an outer boundary and sometimes one or more inner boundaries.

To improve accuracy for fusing a solid area, the fusion process includes a separate fusion of a contour and a hatch pattern. The contour is a fusion pathway that follows the boundary. On the other hand, the hatch pattern is a sequence of parallel fusion pathways or vectors that fill the region of the solid area within the contour. The use of contours and hatching to form solid areas is effective until the solid areas become numerous and small in terms of width dimension or area. An example of many small features is the formation of a lattice structure which involves many very narrow solid areas. Then the contour and hatch pattern method becomes quite burdensome because many small isolated vectors need to be formed and the cost is an amount of scanning time required to form these features.

### BRIEF DESCRIPTION OF THE FIGURES

FIG. 1 is a schematic diagram of a three-dimensional (3D) printing system for fabricating a 3D article.

FIG. 2 is a “data flow” diagram for a controller to show a sequence of software modules that act upon an incoming virtual three-dimensional (3D) body such as a computer aided design (CAD) file.

FIG. 3 is a flowchart of a method for processing a virtual 3D body into vectorized slices. The term “vectorized” is essentially the replacement of solid areas of a virtual slice with vectors. An energy beam following the vectors over the build plane can provide corresponding melted and fused solid areas.

FIG. 4 is a flowchart of a method for fabricating a 3D article.

FIG. 5 is an isometric drawing of at least a portion of a virtual 3D body.

FIG. 6 is a diagram depicting a solid area that is part or all of a virtual cross-sectional slice. Solid area(s) of a virtual cross-sectional slices are those areas in a layer to be selectively fused. The term “solid area” can refer to a virtually or actually solidified area of a slice.

FIG. 7 is a simple diagram intended to represent a selectively fused path within a layer of powder represented by a vector. The term “vector” means a portion or all of a path taken by a laser beam to selectively fuse the path.

FIG. 8 is an embodiment of a method of analyzing and vectorizing a solid area of a virtual cross-sectional slice. Because one virtual slice may have more than one solid area, the method 70 may be performed multiple times for one virtual slice. The result of performing method 70 on all solid areas of a virtual slice is a vectorized slice.

FIG. 9A is a diagram representing vectorization of a solid area having a width (W) above an upper threshold. The vectorization includes contour and hatch vectors.

FIG. 9B is a diagram representing vectorization of a solid area having a width (W) below an upper threshold but above a lower threshold. The vectorization is a zig-zag sequence of vectors that advance along a length and alternate or point back and forth along a width of the solid area.

### SUMMARY

A first aspect of the disclosure is a method for manufacturing a three-dimensional (3D) article. The method includes operating a vertical movement mechanism to position an upper surface of a build plate or the 3D article proximate to a build plane, operating a coater to dispense a layer of a powder material upon the upper surface, operating a beam system to selectively fuse the layer of powder material including fusing at least one solid area of the layer of powder material, and further operating the vertical movement mechanism, the coater, and the beam system to complete fabrication of the 3D article. For individual solid areas—operation of the beam system to selectively fuse the solid area of powder is according to one of three modes including a first mode (A), a second mode (B), and a third mode (C). The particular mode selected is based upon a comparison of a dimensional parameter of the solid area with two dimensional thresholds including an upper dimensional threshold and a lower dimensional threshold. (A) If the dimensional parameter is above the upper dimensional threshold, then the solid area is fused by (1) fusing a contour that forms a boundary for the solid area and (2) separately fusing a fill area within the contour. The (1) contour is fused by scanning the energy beam along a path that traces around the boundary of the solid area. The (2) fill area is fused by scanning the energy beam in a hatch pattern that include a side-by-side arrangement of parallel vectors that are within the fill area bounded by the contour. (B) If the dimensional parameter is between the upper and lower dimensional thresholds, then the solid area is fused with a zig-zag pattern of vectors. (C) If the dimensional parameter is below the lower dimensional threshold, then the solid area is fused with a vector that follows the long axis of the solid area.

This method has a substantial speed advantage over prior methods when intricate structures with many fine features are fabricated. It is particularly advantageous for fabricating lattices. When fine features—i.e., small solid areas are fabricated using mode (A), the scanner spends much of the fabrication time repositioning the energy beam for solidifying along very short vectors. Therefore the time spent selectively fusing a layer with many fine features is extremely time consuming. Replacing mode (A) with mode (B) allows the use of the zig-zag pattern that can be performed one vector after another without repositioning. Because the solid area is small, the pattern provides complete fill area fusion and defines a border within typical tolerances driven by surface tension. That is because the fine features are not much larger than a melt width for a typical scan vector—so having a contour as in mode (A) does not significantly add to precision but has a large productivity cost. Thus, this method provides the same geometric accuracy with much less scanning time.

In one implementation, the dimensional parameter is a width (W) of the solid area. The upper dimensional threshold can be a multiple of a melt width (mw). The upper dimensional threshold can be, for example, three times mw, four times mw, five times mw or some other integer or non-integer factor times the melt width (mw). The upper dimensional threshold can be less than about 0.5 millimeter (mm), less than about 0.4 mm, or less than about 0.3 mm to name some examples.

When the solid area has a major axis and a minor axis (e.g., elongate rectangle, elongate oval, etc.) the width (W) is measured along the minor axis. For a symmetrical object like a circle or square, the width (W) can be measured at more than one orientation. For a circle, W is the diameter. For a square, W is the length of a side. For a regular polygon, W can be a distance between two opposing sides. For an irregular shape, W may be considered to be a distance between two sides with the sides being a weighted average position of the sides with respect to an axial direction that W is measured over.

The melt width (mw) is the width of a melted and fused segment of material that is formed as the energy beam is scanned along a vector pathway. The melt width (mw) is measured perpendicular to the vector pathway. In an illustrative example, the melt width (mw) can be in a range of 100-150 microns or 0.10 to 0.15 millimeter (mm). One millimeter equals 1000 microns as a linear dimension.

In another implementation, the dimensional parameter is an area magnitude in square millimeters of the solid area. The upper dimensional threshold can be 0.5 square mm to name an example. The lower dimensional threshold can be 0.05 square mm to name an example.

In yet another implementation, the dimensional parameter can include two parameters including a width (W) and an area of the solid area. The upper and lower dimensional thresholds can put limits on both parameters or even has a functional relationship between the two parameters to define the threshold.

### DETAILED DESCRIPTION OF THE PREFERRED EMBODIMENTS

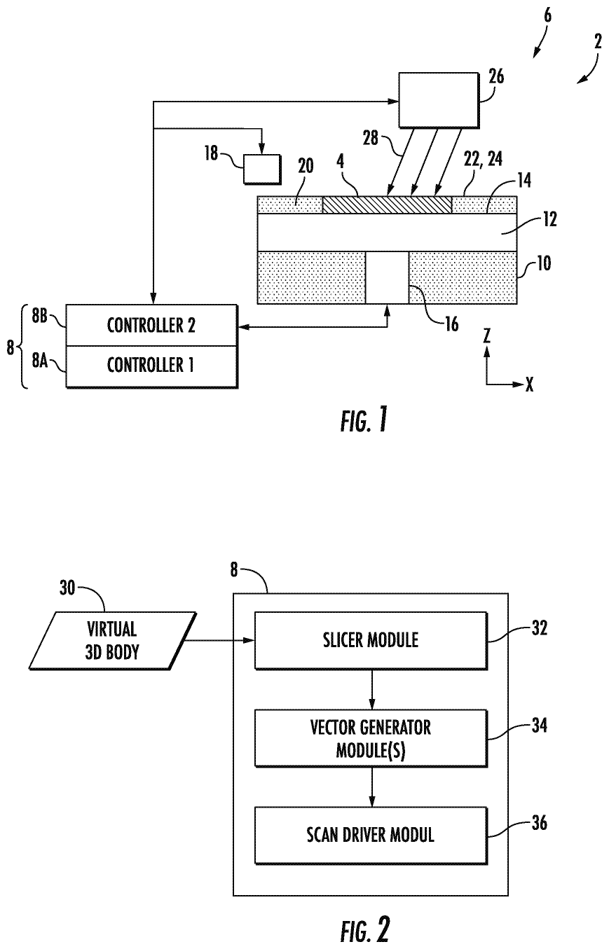

FIG. 1 is a schematic diagram of a three-dimensional (3D) printing system 2 for fabricating a 3D article 4. 3D printing system 2 includes a 3D print engine 6 coupled to a controller 8. In describing system 2, mutually orthogonal axes X, Y, and Z can be used. The X and Y axes are lateral and generally horizontal. The Z-axis is a vertical axis that is generally aligned with a gravitational reference. By “generally” we mean that a measure such as a quantity, a dimensional comparison, or an orientation comparison is by design and within manufacturing tolerances but as such may not be exact. Further, in discussing features as being “aligned” or “equal” or any other aspect it will be assumed that this is by design and not necessarily exact.

The print engine 6 includes a build module 10 containing a build plate 12 having an upper surface 14 for supporting the 3D article 4. Build plate 12 is coupled to a vertical movement mechanism 16 that is configured to vertically position the build plate 12. Vertical movement mechanisms 16 are well known within the art of 3D printing systems. One example of a vertical movement mechanism 16 is a lead screw drive system. The lead screw is threaded into a nut that is mechanically coupled to the build plate 12. The lead screw is coupled to a motor. As the motor turns the lead screw, the action of outer threads of the lead screw against inner threads of the nut have the effect of controllably translating the nut and the build plate in a vertical direction.

In another embodiment the vertical movement mechanism 16 is a rack and pinion drive system. The “rack gear” is a linear gear mechanically coupled to the build plate 12. The “pinion gear” is a round gear coupled to a motor. Outer teeth of the pinion gear engage the linear rack gear. As the motor turns the pinion gear, the rack gear is translated vertically, along with the build plate. These and other vertical movement mechanisms are known in the art for 3D printing systems.

A coater 18 is configured to deposit layers of powder 20 over the build plate 12. Such coaters 18 are known in the art for 3D printing systems that selectively fuse, sinter, and/or melt layers of powder 20. The coater 18 includes a movement mechanism to translate a powder dispenser over the build plate 12. The movement mechanism can be a lead screw drive system or rack and pinion drive system as described above and are well known. Alternatively, the horizontal movement mechanism can include a robotic gantry system that moves along two or three axes and is also well known. The powder dispenser can dispense powder using a metering roller or a valve mechanism. The powder dispenser can also include a wiper for leveling a deposited layer of powder. When a new layer of powder 20 is deposited over the build plate 12 (or over previously deposited powder 20 and or a top surface of the 3D article 4), the new layer of powder has an upper surface 22 that vertically defines a build plane 24.

One or more beam systems 26 are configured to generate and scan energy beams 28 over the build plane 24. Such beam systems 26 are known in the art for 3D printing systems that selectively fuse, sinter, and/or melt layers of powder 20. In an illustrative embodiment, the beam system 26 includes a laser and a pair of galvanometer mirrors. The pair of galvanometer mirrors receive a radiation beam 28 from the laser and then scan the radiation beam 28 in two dimensions over the build plane 24. The bounds of the build plane 24 are determined vertically by an optimal focus of the beam system 26 and horizontally by an effective scanning range of the beam system 26. Beam system 26 may include additional optics such as an “f-theta” or “flat field” lens set that focus the beams 28 and compensate for angular positioning effected by the galvanometer mirrors. All such optics are known in the art for laser systems used for 3D printing systems that selectively fuse, sinter, and/or melt layers of powder 20. In an alternative embodiment, beam system 26 utilizes electron beams 28. In a further embodiment, the beam system 26 utilizes both electron and radiation beams 28. Such systems are known in the art for sintering, fusing, and melting powder materials.

The controller 8 includes a processor coupled to an information storage device. The processor includes at least one CPU (central processing unit). The information storage device includes a non-transient or non-volatile mass storage device that can include, for example, flash memory and/or magnetic disk drives. The information storage device stores software instructions that, when executed by the controller, monitor and control the print engine 6. In the illustrated embodiment, controller 8 includes two coupled controllers including an internal controller 8A that is integral with and internal to the print engine 6 and an external controller 8B that is external to and/or remote from the internal controller 8A. In other embodiments, controller 8 can be completely integral or external relative to the print engine 6. Internal controllers are sometimes referred to as “microcontrollers”. External controllers can include networked host and server computers.

FIG. 2 is a data flow diagram to illustrate action of software modules of controller 8 upon an incoming virtual three-dimensional (3D) body 30. The virtual 3D body 30 can be a computer aided design (CAD) file that defines the 3D article 4 to be manufactured. The slicer module 32 receives and virtually and horizontally slices the virtual 3D body 30. The output of the slicer module 32 is a sequence of virtual cross-sectional slices which individually define a horizontal 2D cross-section of the virtual 3D body 30. The virtual cross-sectional slices are individually sent to a vector generation module 34 which generates vectorized slices that individually define an arrangement of scan vectors for the slice. The vectorized slices are individually sent to the scan driver module 36 which controls the beam system 26 for individual slices. In an illustrative embodiment, the external controller 8B can include the slicer module 32 and the vector generator module(s) 34. The internal controller 8A can include the scan driver module 36. Other implementations of division between different controllers are possible.

FIG. 3 is a flowchart of method 40 resulting from the execution of software modules 32 and 34 by controller 8 of FIG. 2. According to 42, the controller 8 receives a virtual 3D body 30. Steps 44-48 are then executed N times (from n=1 to n=N) to provide N vectorized slices. In step 44, the virtual 3D body 30 horizontally sliced at a vertical position corresponding to n which results in a horizontal 2D cross section. The horizontal 2D cross section includes one or more solid areas which are areas of powder to be solidified. According to 46, the solid areas are analyzed to determine a vector strategy for each solid area. According to 48, the vector strategies are used to generate vectors. The vector strategy can include selection of a mode for generating the vectors. The selection is based upon a geometry of the solid area.

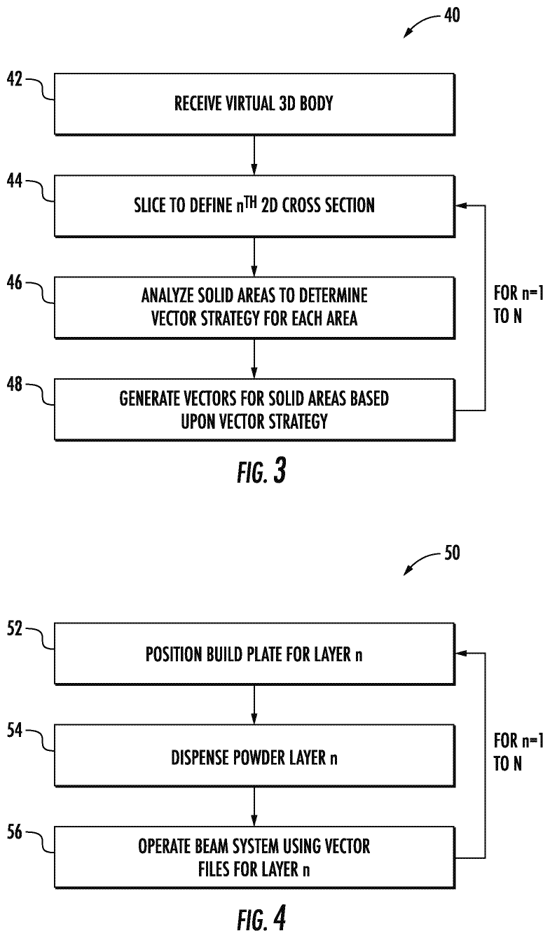

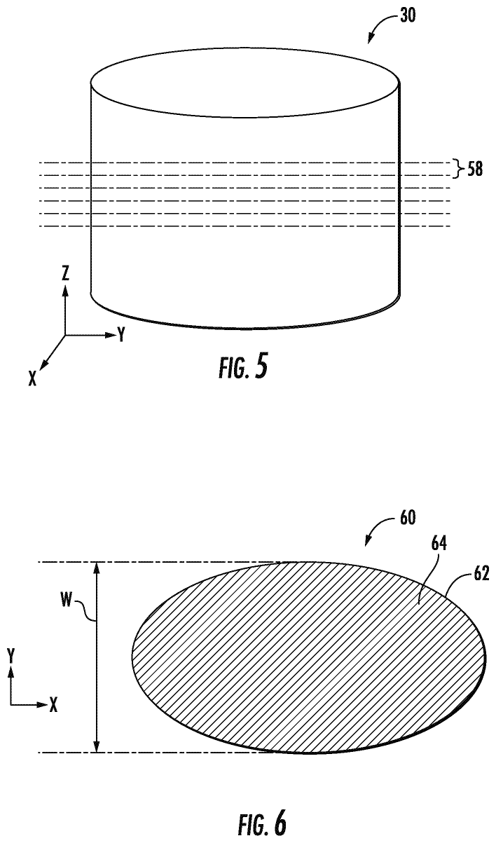

FIG. 4 is a manufacturing method 50 for fabricating the 3D article 4 in a layer-by-layer manner for N layers. Steps 52-56 are executed N times for n=1 to n=N. According to 52, the vertical movement mechanism 16 is operated to vertically position the build plate and the upper surface 22 (or initially upper surface 14 for n=1) at the build plane 24. According to 54, the coater 18 is operated to dispense a layer of powder 20 over the build plate 12. According to 56, the beam system 26 is operated to selectively fuse the just-dispensed layer of powder 20.

FIG. 5 is an isometric drawing of at least a portion of a virtual 3D body 30 in the shape of a right oval cylinder. Also shown are dashed horizontal cut lines for virtual cross-sectional slices 58.

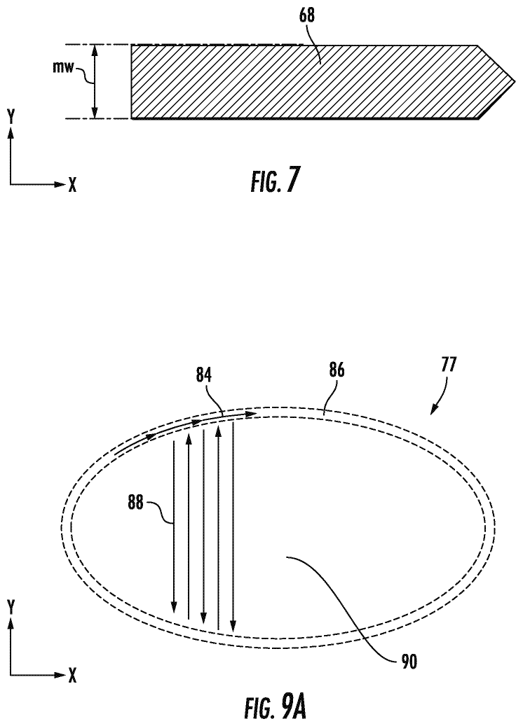

FIG. 6 depicts a solid area 60 that is part or all of a virtual cross-sectional slice 58. The solid area 60 has an outer boundary 62 and a solid interior 64. The illustrated solid area 60 has a major axis aligned with X and a minor axis aligned with Y. The solid area 60 has a width W with respect to the minor axis. Other solid area 60 geometries are possible such as rectangles. The width W of a rectangle would be a dimension of the shortest side—again, along the minor axis. For a circle, W is defined as the diameter. For a square, W is defined as the length of a side. For an irregular or more complex object—the 2D object can be “broken down” into simpler shapes such as rectangles and ovals for purpose of analysis (determination of W) and vectorization (generation of scan vectors for fusing the 2D object.

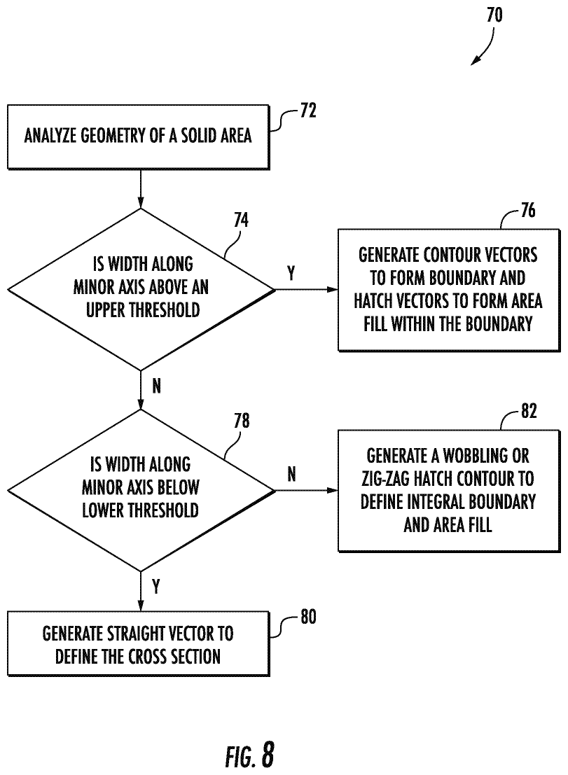

FIG. 7 is a diagram intended to illustrate a single vector 68 which depicts a path of an energy beam 28 across a layer of powder 20. The vector 68 is scanned along X and has a “melt width” (mw) in Y. As the energy beam 28 scans along the layer of powder 20, it results in a melted width (mw) of the powder 20. The melt width can be determined by scanning a sequence of separated vectors 68, removing unbound metal, and then performing a measurement of the width of solidified material. In an illustrative embodiment, the melt width (mw) is typically about 100 to 150 microns (1000 microns equals one millimeter). Thus, the melt width (mw) is in a range of about 0.10 to 0.15 millimeter.

FIG. 8 is an embodiment of a method 70 of analyzing and vectorizing a solid area 60 which corresponds to steps 46 and 48 of FIG. 3 for one solid area 60. The method 70 applies to one single solid area 60 that is some or all of one virtual cross-sectional slice 58. Prior to method 70, the virtual cross-sectional slice 58 may be divided up into solid areas 60 to be analyzed and vectorized.

The method 70 includes a comparison of a dimensional parameter of the solid area 60 with one or more dimensional threshold(s). In a first embodiment, the dimensional parameter is a width (W) of the solid area 60 and the threshold(s) would be based upon a length. In a second embodiment, the dimensional parameter is an area magnitude of the solid area 60. In a third embodiment, the dimensional parameter includes width (W) and area parameters and a comparison can be algorithmic. The illustrative embodiment of FIG. 8 is an example of the first embodiment.

According to 72, the solid area 60 geometry is analyzed. This can include comparing the width (W) of the solid area 60 with the melt width (mw) of a scanned vector 68. According to 74, a determination is made as to whether the width (W) of the solid area 60 is above an upper threshold. The upper threshold can be defined relative to the melt width (mw) such as five times the melt width but the upper threshold can vary. If so, then the process proceeds to step 76.

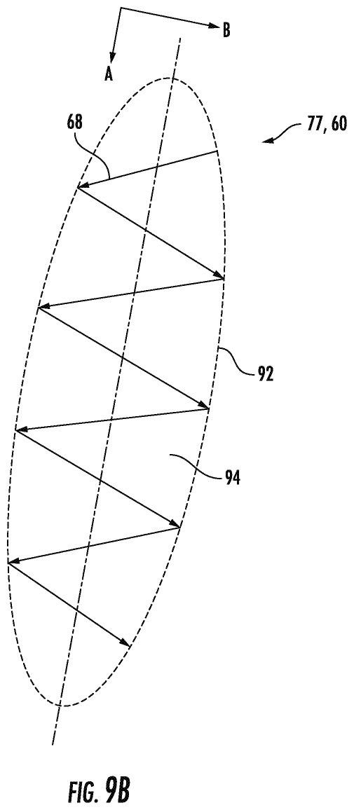

Step 76 is illustrated in FIG. 9A which is a schematic illustration of a vectorization 77 used to solidify an area of powder corresponding to the solid area 60. The vectorization includes contour vectors 84 forming a contour 86 and hatch vectors 88 forming a solidified area fill 90 within the contour 86. Only some contour vectors 84 and hatch vectors 88 are shown in FIG. 9A.

The contour 86 is formed by having an energy beam 28 that scans along the contour 86 with a series of contour vectors 84 with each contour vector 84 scanned from tail to head before the next contour vector 84 is scanned from tail to head. In this way, the energy beam 28 traces around the contour 86. The contour 86 defines the outer boundary of the solid area 60. Similar contours can form internal boundaries where applicable.

The solidified area fill 90 is formed by having an energy beam 28 that scans a series of parallel hatch vectors 88 that fill the region within the contour 86. In the illustrated embodiment, the hatch vectors 88 have a spacing that corresponds to the melt width (mw) so that powder within the solidified area fill 90 is completely solidified. The hatch vectors 88 are parallel or antiparallel to each other.

Referring back to FIG. 8—if the with (W) of the solid area 60 is less than the upper threshold, then the process proceeds to step 78. According to 78, a determination is made as to whether the width (W) of the solid area (60) is below a lower threshold. If the width (W) is below the lower threshold, this typically would indicate that the width (W) is close to equal to the melt width (mw). Then the process proceeds to step 80 and a vector 68 or single vector 68 is scanned to form the solid area 60.

If the width (W) of the solid area is between the upper and lower thresholds, then the process proceeds to step 82. According to 82, a wobbling or zig-zag vector pattern is scanned to form both the outer boundary and internal area fill of the solid area 60. The solid area 60 can be described with respect to an “advance axis A” and “wobble axis B”.

FIG. 9B is a particular illustration of the vectorization 77 of the solid area 60 for step 82. In the illustrative embodiment, the solid area 60 has a major axis along advance axis A and a minor axis along wobble axis B. The vectorization includes a sequence of vectors 68 that sequentially advance positively along axis A and alternate back and forth along axis B. Stated another way, the vectors sequentially point in the same (+A) direction along A and sequentially alternate in opposing directions along B. This can be defined as a zig-zag vectorization pattern 77. In step 82 the vectorization simultaneously provides both an outer boundary 92 and a solid area fill 94 for the solid area 60. Also, vectors 68 are not parallel but define oblique angles with respect to each other. However, every other vector 68 has the same direction. Also, the vectors 68 individually define an oblique angle with respect to the advance axis A and the wobble axis B. In the illustrated embodiment, the vectors 68 define roughly a 60 degree angle with respect to the advance axis A and a 30 degree angle with respect to the wobble axis B.

While the solid area 60 illustrated in FIG. 9B is an elongate oval, other elongate shapes are possible such as an elongate rectangle, and elongate polygon, or an elongate irregular shape. Small symmetrical areas such as a square or circle can also be fabricated. While the illustrated vectorization is zig-zag, other patterns are possible such as a wobbling scan path that proceeds along A while wobbling along B. Such wobbling can have some other shape such as curved or sinusoidal. Whether wobbling or zig-zag, this can be described as a path or series of vectors that advances along A and wobbles along B.

The specific embodiments and applications thereof described above are for illustrative purposes only and do not preclude modifications and variations encompassed by the scope of the following claims.

What is claimed:

1. A method for manufacturing a three-dimensional (3D) article:
operating a vertical movement mechanism to position an upper surface of a build plate or the 3D article proximate to a build plane;
operating a coater to dispense a layer of a powder material upon the upper surface;
operating a beam system to selectively fuse the layer of powder material including fusing at least one solid area of the layer of powder material using one of two operating modes based upon a comparison of a dimensional parameter of the solid area with dimensional thresholds:
if the dimensional parameter is above an upper dimensional threshold, fusing the solid area by fusing a contour that forms a boundary for the solid area and fusing a fill area that is enclosed by the contour;
the contour is fused by scanning an energy beam along a path that traces along the boundary;
the fill area is fused by scanning the energy beam in a hatch pattern that includes a side-by-side arrangement of parallel vectors within the contour;
if dimensional parameter is below the upper dimensional threshold but above a lower dimensional threshold, fusing the solid area with a zig-zag pattern of vectors; and
further operating the vertical movement mechanism, the coater, and the beam system to complete fabrication of the 3D article.

2. The method of claim 1 wherein the dimensional parameter is a width (W) of the solid area.

3. The method of claim 2 wherein scanning the energy beam over the layer of powder material melts the powder material over a melt width, the upper dimensional threshold is less than five times the melt width.

4. The method of claim 2 wherein the upper dimensional threshold is less than 0.5 millimeters (mm).

5. The method of claim 2 wherein the dimensional parameter includes two dimensional parameters including the width (W) of the solid area and an area magnitude of the solid area.

6. The method of claim 1 wherein the dimensional parameter is an area magnitude of the solid area.

7. The method of claim 1 wherein if the solid area has a dimensional parameter below the lower dimensional threshold, then selectively fusing the solid area with a straight vector oriented along a long axis of the solid area.

8. A non-transient storage device storing software instructions for manufacturing a three-dimensional (3D) article, when executed by a processor the software instructions:
operate a vertical movement mechanism to position an upper surface of a build plate or the 3D article proximate to a build plane;
operate a coater to dispense a layer of a powder material upon the upper surface;
operate a beam system to selectively fuse the layer of powder material including fusing at least one solid area of the layer of powder material using one of two operating modes based upon a comparison of a dimensional parameter of the solid area with dimensional thresholds:
if the dimensional parameter is above an upper dimensional threshold, fusing the solid area by fusing a contour that forms a boundary for the solid area and fusing a fill area that is enclosed by the contour;
the contour is fused by scanning an energy beam along a path that traces along the boundary;
the fill area is fused by scanning the energy beam in a hatch pattern that includes a side-by-side arrangement of parallel vectors within the contour;
if dimensional parameter is below the upper dimensional threshold but above a lower dimensional threshold, fusing the solid area with a zig-zag pattern of vectors; and
further operate the vertical movement mechanism, the coater, and the beam system to complete fabrication of the 3D article.

9. The non-transient storage device of claim 8 wherein the dimensional parameter is a width (W) of the solid area.

10. The non-transient storage device of claim 9 wherein scanning the energy beam over the layer of powder material melts the powder material over a melt width, the upper dimensional threshold is less than five times the melt width.

11. The non-transient storage device of claim 9 wherein the upper dimensional threshold is less than 0.5 millimeters (mm).

12. The non-transient storage device of claim 9 wherein the dimensional parameter includes two dimensional parameters including the width (W) of the solid area and an area magnitude of the solid area.

13. The non-transient storage device of claim 8 wherein the dimensional parameter is an area magnitude of the solid area.

14. The non-transient storage device of claim 8 wherein if the solid area has a dimensional parameter below the lower dimensional threshold, then selectively fusing the solid area with a straight vector oriented along a long axis of the solid area.

15. A three-dimensional printing system for manufacturing a three-dimensional (3D) article comprising a controller configured to:
operate a vertical movement mechanism to position an upper surface of a build plate or the 3D article proximate to a build plane;
operate a coater to dispense a layer of a powder material upon the upper surface;
operate a beam system to selectively fuse the layer of powder material including fusing at least one solid area of the layer of powder material using one of two operating modes based upon a comparison of a dimensional parameter of the solid area with dimensional thresholds:
if the dimensional parameter is above an upper dimensional threshold, fusing the solid area by fusing a contour that forms a boundary for the solid area and fusing a fill area that is enclosed by the contour;
the contour is fused by scanning an energy beam along a path that traces along the boundary;
the fill area is fused by scanning the energy beam in a hatch pattern that includes a side-by-side arrangement of parallel vectors within the contour;
if dimensional parameter is below the upper dimensional threshold but above a lower dimensional threshold, fusing the solid area with a zig-zag pattern of vectors; and
further operate the vertical movement mechanism, the coater, and the beam system to complete fabrication of the 3D article.

16. The three-dimensional printing system of claim 15 wherein the dimensional parameter is a width (W) of the solid area.

17. The three-dimensional printing system of claim 16 wherein scanning the energy beam over the layer of powder material melts the powder material over a melt width, the upper dimensional threshold is less than five times the melt width.

18. The three-dimensional printing system of claim 16 wherein the upper dimensional threshold is less than 0.5 millimeters (mm).

19. The three-dimensional printing system of claim 16 9 wherein the dimensional parameter includes two dimensional parameters including the width (W) of the solid area and an area magnitude of the solid area.

20. The three-dimensional printing system of claim 15 wherein if the solid area has a dimensional parameter below the lower dimensional threshold, then selectively fusing the solid area with a straight vector oriented along a long axis of the solid area.
